(19) United States
(12) Patent Application Publication
(10) Pub. No.: US 2010/0299904 A1
(43) Pub. Date: Dec. 2, 2010

(54) METHOD AND APPARATUS FOR SCREWING PISTONS OF SYRINGES

(76) Inventors: Angelo Ansaloni, Crespellano (IT); Ernesto Gamberini, Rastignano (IT)

Correspondence Address: GOTTLIEB RACKMAN & REISMAN PC, 270 MADISON AVENUE, 8TH FLOOR, NEW YORK, NY, 10016-0601, US

(21) Appl. No.: 12/785,089

(22) Filed: May 21, 2010

(30) Foreign Application Priority Data
May 26, 2009 (IT) BO2009A000340

(51) Int. Cl. B23P 11/00; B23P 19/04

(52) U.S. Cl. 29/428; 29/240

(57) ABSTRACT

A method and apparatus for screwing pistons of syringes, each defined by a corresponding cylinder fluid-tightly sealed by a plug made of elastomeric material and a corresponding piston screwed into the plug itself, according to which each cylinder and corresponding piston are coaxially fed along a given path, and are respectively turned to screw the piston into the corresponding plug; the screwing of each piston into the corresponding plug being controlled by measuring either the value of a screwing torque or of a magnitude according to the screwing torque itself.

The present invention relates to an apparatus for screwing pistons of syringes.

### BACKGROUND OF THE INVENTION

In particular, the present invention relates to an apparatus for screwing pistons of syringes, each of which has a given longitudinal axis, and comprises a cylinder fluid-tightly sealed by means of a plug made of elastomeric material mounted within the cylinder and an actuating piston screwed into the plug itself.

The apparatus comprises a feeding line, for feeding in sequence the cylinders and corresponding pistons, which are coaxial to each other, along a given path, and comprises a plurality of first gripping and conveying devices, each of which is pivotally engaged by a corresponding cylinder and a plurality of second gripping and conveying devices, each of which is adapted to receive and hold a corresponding piston; and a rolling block made of elastomeric material arranged along the path to turn each cylinder about the corresponding axis and to fasten the corresponding plug on the corresponding piston.

The position of the rolling block with respect to the cylinders is selectively controlled so as to prevent, after having completed the screwing, a further rotation of the cylinders, allowing at the same time the sliding of the syringes on the rolling block itself.

Because the cylinders of the syringes of a given diameter may reciprocally differ due to the contemplated tolerances of the diameter itself and the rolling block may wear, the apparatuses for screwing syringes of the above-described known type display some drawbacks, mainly deriving from the fact that the friction conditions between cylinders and rolling block may vary, thus compromising the correct screwing of each cylinder in the respective plug.

### SUMMARY OF THE INVENTION

It is an object of the present invention to provide an apparatus for screwing pistons of syringes which is free from the above-described drawbacks and which is simple and cost-effective to implement.

According to the present invention, there is provided an apparatus for screwing pistons of syringes as claimed in the attached claims.

The present invention further relates to a method for screwing pistons of syringes.

According to the present invention, there is provided a method for screwing pistons of syringes as claimed in the attached claims.

### BRIEF DESCRIPTION OF THE DRAWINGS

The present invention will now be described with reference to the accompanying drawings, which illustrate a non-limitative embodiment thereof, in which:

FIG. 1 is a diagrammatic plan view, with parts removed for clarity, of a preferred embodiment of the apparatus according to the present invention;

FIG. 2 is a first diagrammatic side view, with parts removed for clarity, of a detail of the apparatus in FIG. 1;

FIG. 3 is a first diagrammatic side view, with parts removed for clarity, of a detail in FIG. 2;

FIG. 4 is a second diagrammatic side view, with parts removed for clarity, of the detail in FIG. 3; and

FIG. 5 is a diagrammatic plan view, with parts removed for clarity, of the detail in FIGS. 3 and 4.

### DETAILED DESCRIPTION OF THE INVENTION

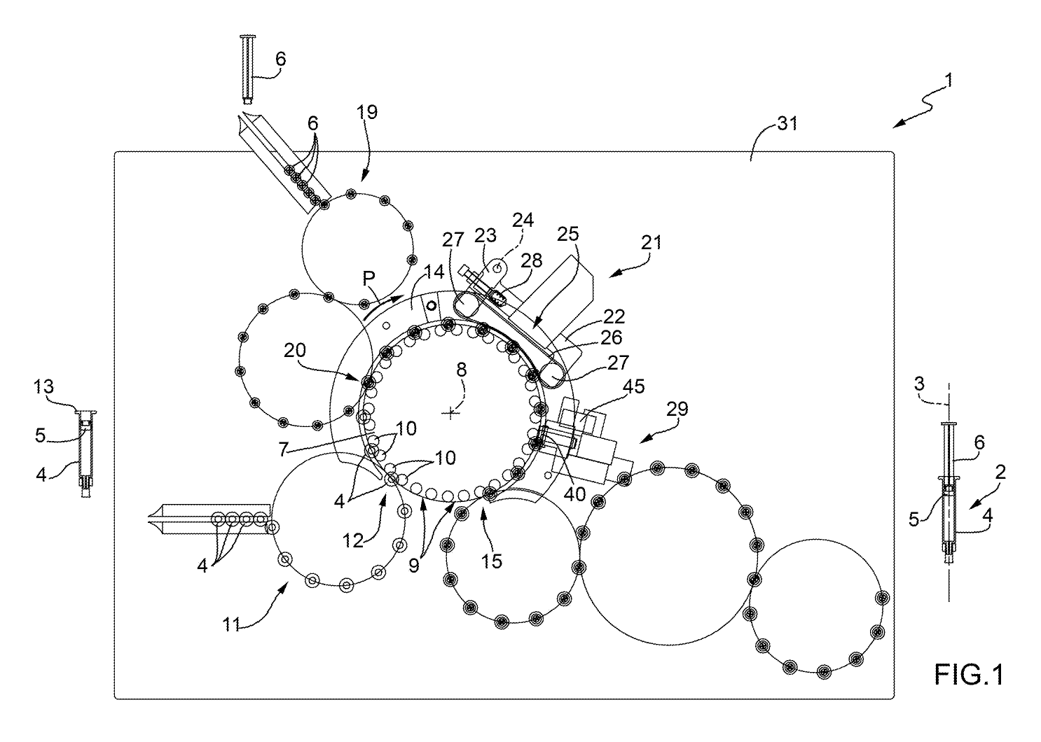

With reference to FIG. 1, numeral 1 indicates, as a whole, an apparatus for screwing pistons of syringes 2, each of which has a given longitudinal axis 3 and comprises a cylinder 4 for containing a product, in the case in point a medical product, a plug 5 made of elastomeric material adapted to fluid-tightly close the cylinder 4 and an actuating piston 6 screwed into the plug 5 itself.

The apparatus 1 comprises a feeding wheel 7, which is motorized, in a know manner (not shown), to continuously rotate about a longitudinal axis 8 thereof vertical and perpendicular to the sheet in FIG. 1, and is provided with a plurality of pockets 9, which are uniformly distributed along the periphery of the wheel 7 about the axis 8, and each comprises two corresponding cylindrical rollers 10 mounted parallel to the axis 8 and reciprocally arranged at a distance smaller than the diameter of the cylinder 4 of a syringe 2.

The cylinders 4, filled with product and fluid-tightly closed by the corresponding plugs 5, are fed in sequence to the corresponding pockets 9 by a feeding device 11 connected to the wheel 7 at an inlet station 12, and are withheld in the corresponding pockets 9 by the corresponding upper annular flanges 13 and by a fixed containment slat 14, which extends about axis 8, and opens at the station 12 and at an outlet station 15 of the syringes 2 from the wheel 7.

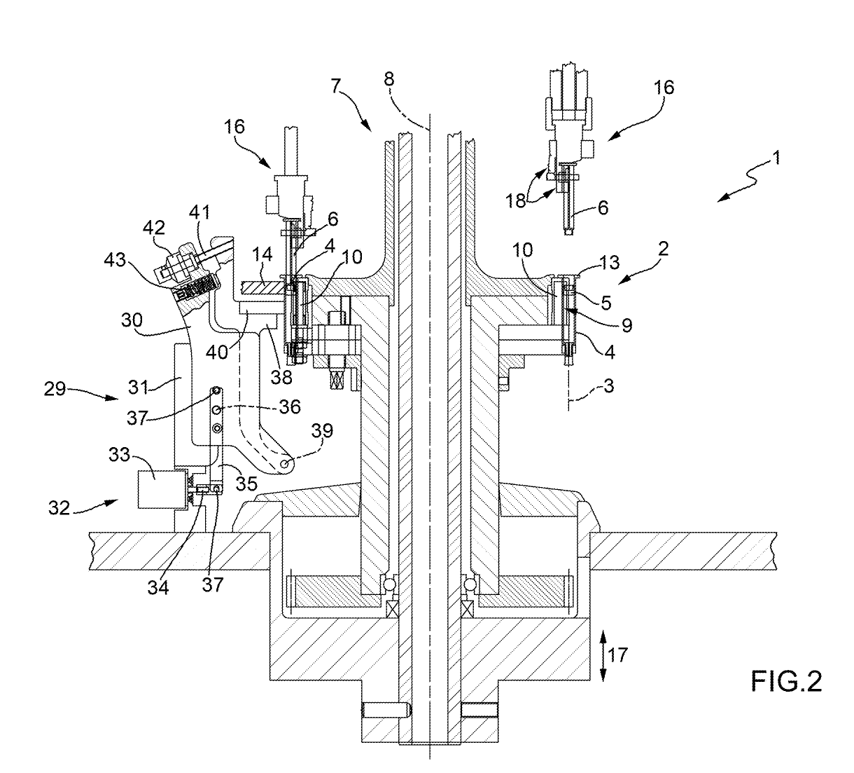

As shown in FIG. 2, wheel 7 is further provided with a plurality of gripping and conveying members 16, which are uniformly distributed about axis 8, are each aligned with a corresponding pocket 9 in a vertical direction parallel to axis 8, and each comprise two corresponding gripping jaws 18 movable between a clamping position and a releasing position of a corresponding piston 6.

With reference to FIG. 1, the pistons 6 are fed in sequence to the corresponding members 16 by a feeding device 19 connected to the wheel 7 at an input station 20, and are withheld by respective members 16 in position coaxial to the corresponding cylinders 4.

The apparatus 1 further comprises a first screwing device 21, which is arranged along a feeding path P of the cylinders 4 between the stations 12 and 15, and comprises, in turn, a supporting plate 22, a crank 23 hinged to the plate 22 to oscillate, with respect to the plate 22, about a fulcrum axis 24 parallel to the direction 17, and a rolling assembly 25 comprising a belt 26 looped about a pair of pulleys 27, one fixed to the plate 22 and the other fixed to the crank 23.

The radial position of the plate 22 with respect to the piston 8 is selectively adjusted according to the diameter of the cylinders 4, while the tension of the belt 26 is maintained substantially constant by means of a spring 28 arranged between the plate 22 and the crank 23.

The apparatus 1 is further provided with a second screwing device 29, which is arranged along the path P downstream of the device 21 in the sense of rotation of the wheel 7, and comprises a slide 30 slidingly coupled to a fixed frame 31 of the apparatus 1 to carry out rectilinear movements in a direction substantially radial with respect to axis 8 with respect to the frame 31 and under the bias of an actuating device 32.

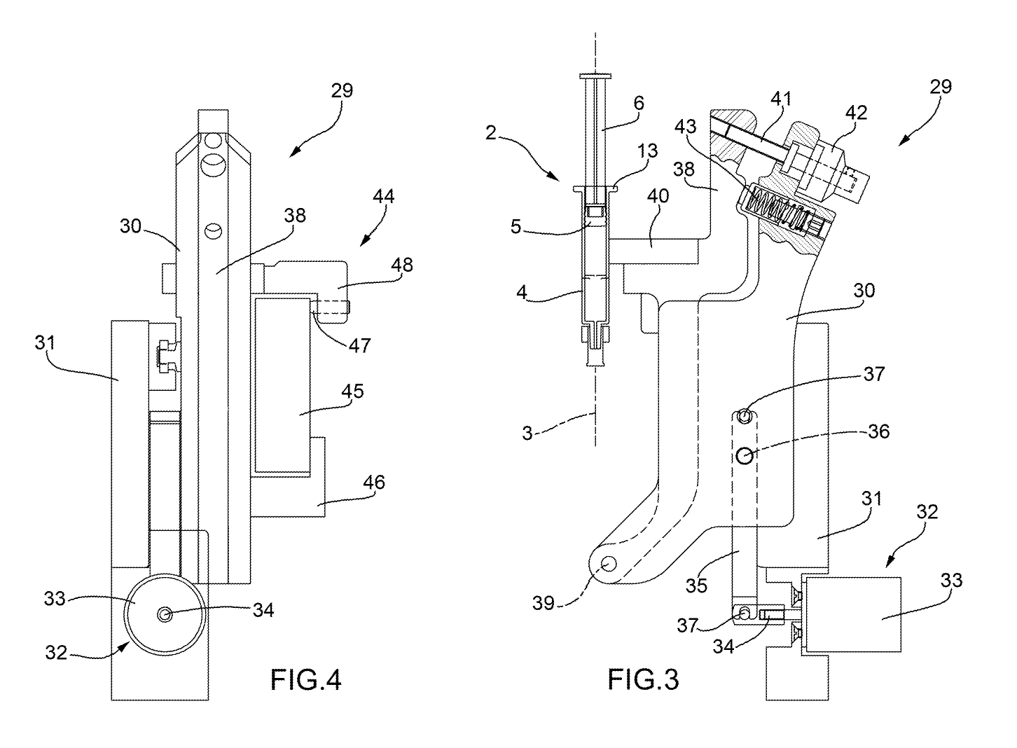

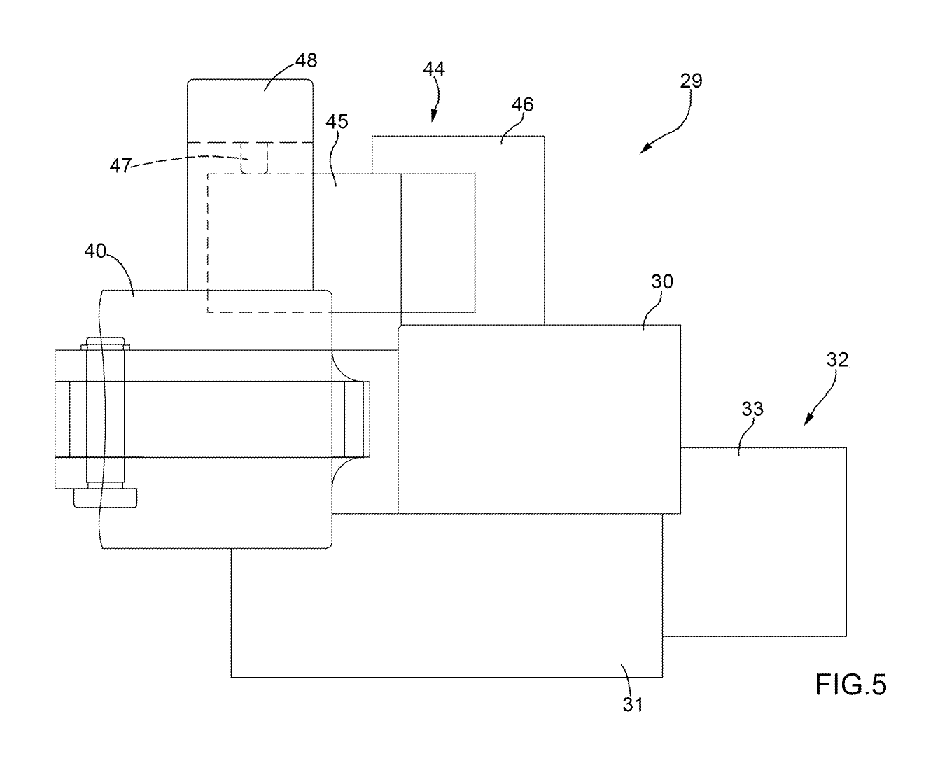

As shown in FIGS. 1, 3, 4, and 5, the device 32 comprises an actuating cylinder 33, in the case in point an electromagnet of known type, which is fixed to the frame 31, extends radially with respect to the axis 8, and has an outlet rod 34 connected to the slide 30 by means of the interposition of a rocker arm 35, which is hinged to the frame 31 to oscillate, with respect to the frame 31 itself, about a substantially horizontal fulcrum axis 36 traversal to direction 17, and comprises two arms, the ends of which are fork-shaped, and are coupled one to the slide 30 and the other to the rod 34 by means of corresponding coupling pins 37 slidingly engaged in the ends themselves.

The device 29 further comprises a crank 38, which is pivotally engaged to the slide 30 to oscillate with respect to the slide 30 itself about a fulcrum axis 39 parallel to the axis 36, is coupled to the slide 30 with a given side clearance in a tangential direction parallel to the path P, and carries connected a rolling block 40 made of elastomeric material facing the path P itself.

The position of the crank 38 about the axis 39 is selectively controlled by means of an adjustment screw 41, which extends through the slide 30, is screwed into the crank 38, and has a head 42 arranged in contact with the slide 30 on opposite side of the crank 38, and is maintained by a spring 43 interposed between the slide 30 and the crank 38 itself.

The device 29 is associated to a measuring device 44 comprising, in the case in point, a force sensor 45, in the case in point a load cell, which is fixed to the slide 30 by means of a supporting bracket 46, is arranged upstream of the block 40 in the sense of rotation of the wheel 7, and cooperates with an actuating pin 47 which extends parallel to the path P, is screwed through a supporting bracket 48 fixed to the crank 38, and is arranged upstream of the sensor 45 in the sense of rotation of the wheel 7 and in contact with the sensor 45 itself.

The operation of the apparatus 1 will now be described with reference to FIG. 1, assuming the screwing of a piston 6 in the plug 5 of the corresponding cylinder 4, and starting from an instant in which the belt 26 and the block 40 are correctly positioned with respect to the path P and the pin 47 is correctly positioned in contact with the sensor 45.

The cylinder 4 and the piston 6 are fed by the devices 11 and 19, respectively, to the stations 12 and 20, respectively, in phase with a pocket 9 and with the corresponding member 16, respectively, are transferred to the pocket 9 and to the member 16, respectively, so as to be reciprocally coaxial, and are advanced by the wheel 7 about the axis 8 (clockwise in FIG. 1).

At this point, the cylinder 6 is lowered by the member 16 into the cylinder 4 and in contact with the plug 5, and the cylinder 4 comes into contact with the belt 26, which imparts a rotary movement to the cylinder 4 itself about the axis 3 (anticlockwise in FIG. 1) so as to partially screw the plug 5 onto the piston 6 itself.

Subsequently, the cylinder 4 comes into contact with the rolling block 40, which imparts a rotary motion to the cylinder 4 itself about the axis 3 (anticlockwise in FIG. 1) so as to completely screw the plug 5 onto the piston 6.

Due to the friction force between the cylinder 4 and the block 40 and the rotation of the wheel 7 about the axis 8, the crank 38 and, thus, the pin 47 are laterally moved parallel to the path P and in the same sense as the wheel 7, and the pin 47 is clamped against the sensor 45 with a clamping force according to the tightening torque of the plug 5 on the piston 6.

Because the devices 32 and 44 are connected to an electronic control unit (not shown) of the apparatus 1, the device 44 allows to:

control the movement of the slide 30 from an advanced operating position, in which the block 40 is arranged in contact with the cylinder 4, to a retracted resting position, in which the block 40 disengages the cylinder 4 itself, when the value of the clamping force measured by the device 44 is at least equal to a threshold value chosen in an interval of values comprised between a minimum value corresponding to a correct screwing of the plug 5 on the piston 6 without sliding of the cylinder 4 on the plug 5 and a maximum value over which the cylinder 4 slides on the plug 5 itself;

compare the value of the clamping force measured by the device 44 with the above mentioned range of values and selectively control the advanced operating position of the block 40 by means of the screw 41 so that the value of the clamping force measured by the device 44 is comprised in the range of values; and

control the correct screwing of each piston 6 into the respective plug 5.

According to a variant not shown, the apparatus 1 comprises an ejector device mounted upstream of the device 29 to reject the syringes 2 when the value measured by the device 44 is different from at least one threshold value, and is in particular lower than the mentioned minimum and/or maximum of the mentioned maximum value.

According to a further variant not shown the measuring device 44 is eliminated and replaced by a measuring device mounted on each pocket 9 and/or on the corresponding member 16 to directly measure the screwing torque of each piston 6 in the corresponding plug 5.

1. An apparatus for screwing pistons of syringes, each syringe having a given longitudinal axis and comprising a cylinder fluid-tightly sealed by means of a plug made of elastomeric material mounted inside the cylinder and an actuating piston screwed into the plug itself, the apparatus comprising a feeding line for feeding at least one cylinder and a corresponding piston which are coaxial to each other along a given path; and screwing means arranged along the path to reciprocally move each cylinder and the corresponding piston about said corresponding axis and reciprocally screwing the piston and the corresponding plug; and being characterized in that it further comprises a measuring device for measuring either the value of a screwing torque of each piston with the corresponding plug or the value of a magnitude according to the screwing torque itself.

2. An apparatus according to claim 1, wherein the screwing means comprise rolling means for engaging the cylinders to move the cylinders themselves about corresponding axes; an adjustment device being provided to adjust an operative rolling position of the rolling means according to a comparison of the value measured by the measuring device with at least one threshold value.

3. An apparatus according to claim 1, wherein the screwing means comprise rolling means, for engaging the cylinders to move the cylinders themselves about corresponding axes; an actuating device being provided to move the rolling means from an operative rolling position to a resting position in which the cylinders are released when the value measured by the measuring device is at least equal to a given threshold value.

4. An apparatus according to claim 1 and further comprising an ejection device for rejecting the syringes downstream of the screwing means when the value measured by the measuring device is different from at least one threshold value.

5. An apparatus according to claim 1, wherein the screwing means comprise rolling means which are movable in a direction which is tangential to the path under the bias of the cylinders; the measuring device comprising a force sensor mounted in a fixed position in said tangential direction and an actuating member carried by the rolling means for stressing the force sensor upon a displacement of the rolling means in the tangential direction itself.

6. An apparatus according to claim 1, wherein the screwing means comprise first and second screwing means sequentially arranged along the path in order to partially and totally screwing each piston into the corresponding plug, respectively; the measuring device being associated with the second screwing means.

7. An apparatus according to claim 6, wherein the first and second screwing means comprise first and second rolling means, respectively.

8. An apparatus according to claim 1, wherein the feeding line comprises a plurality of first gripping and conveying devices, each of which is pivotally engaged by a corresponding cylinder, and a plurality of second gripping and conveying devices, each of which is adapted to receive and hold a corresponding piston.

9. A method for screwing pistons of syringes, each syringe having a given longitudinal axis and comprising a cylinder fluid-tightly sealed by means of a plug made of elastomeric material mounted inside the cylinder and an actuating piston screwed into the plug itself, the method comprising the steps of:
feeding at least one cylinder and a corresponding piston which are coaxial to each other along a given path; and
reciprocally moving each cylinder and the corresponding piston about said corresponding axis to reciprocally screw the piston and the corresponding plug;
and being characterized in that it further comprises the step of:
measuring either the value of a screwing torque of each piston with the corresponding plug or the value of a magnitude according to the screwing torque itself.

10. A method according to claim 9, wherein each cylinder and the corresponding piston are moved about said corresponding axis when feeding them along the path, and wherein said value is measured when screwing the piston and the corresponding plug.

11. A method according to claim 9 and further comprising the steps of:
moving the cylinders about said corresponding axes by means of rolling means arranged along the path; and
adjusting an operative rolling position of the rolling means according to a comparison of the measured value with at least one threshold value.

12. A method according to claim 9 and further comprising the steps of:
moving the cylinders about said corresponding axes by means of rolling means arranged along the path; and
moving the rolling means from an operative rolling position of the cylinders to a resting position in which the cylinders themselves are released when the measured value is at least equal to a given threshold value.

13. A method according to claim 9 and further comprising the step of:
rejecting the syringes at the end of the screwing step when the measured value is different from at least one threshold value.

14. A method according to claim 9 and further comprising the steps of:
partially screwing the pistons in the corresponding plugs by means of first rolling means arranged along said path;
totally screwing the pistons in the corresponding plugs by means of second rolling means sequentially arranged along said path with respect to the first rolling means; and
measuring said value during the operation of the second rolling means.
